(19) United States
(12) Patent Application Publication
(10) Pub. No.: US 2010/0017556 A1
(43) Pub. Date: Jan. 21, 2010

(54) NON-VOLATILE MEMORY STORAGE SYSTEM WITH TWO-STAGE CONTROLLER ARCHITECTURE

(75) Inventors: Roger Chin, San Jose, CA (US); Gary Wu, Fremont, CA (US)

Correspondence Address: Tung & Associates, Suite 120, 838 W. Long Lake Road, Bloomfield Hills, MI, 48302, US

(73) Assignee: Nanostar Corporationm U.S.A.

(21) Appl. No.: 12/372,028

(22) Filed: Feb. 17, 2009

Related U.S. Application Data
(63) Continuation-in-part of application No. 12/218,949, filed on Jul. 19, 2008.
Application No. 12/218,949 is a continuation-in-part of application No. 12/271,885, filed on Nov. 15, 2008.

(51) Int. Cl. G06F 12/00; G06F 12/02

(52) U.S. Cl. 711/103; 711/115; 711/114; 711/E12.001; 711/E12.008

(57) ABSTRACT

The present invention discloses a non-volatile memory storage system with two-stage controller, comprising: a plurality of flash memory devices; a plurality of first stage controllers coupled to the plurality of flash memory devices, respectively, wherein each of the first stage controllers performs data integrity management as well as writes and reads data to and from a corresponding flash memory device; and a storage adapter communicating with the plurality of first stage controllers through one or more internal interfaces.

### CROSS REFERENCE TO RELATED APPLICATIONS

The present invention is a continuation-in-part application of U.S. Ser. No. 12/218,949, filed on Jul. 19, 2008, and of U.S. Ser. No. 12/271,885, filed on Nov. 15, 2008.

### BACKGROUND OF THE INVENTION

1. Field of the Invention

The present invention relates to a non-volatile memory (NVM) storage system, such as solid state drive (SSD) utilizing two-stage controller architecture to provide a high performance and reliable storage system. The system provides wear-leveling, RAID control and other data integrity management functions as desired, and preferably includes a shared cache memory.

2. Description of Related Art

Hard disk drive (HDD) has been the standard secondary storage device in computer system for many years. However, NAND Flash memory, a solid-state device having lighter weight, faster speed and lesser power consumption over disk, is being used in some applications to replace HDD. The only concern that hinders SSD from taking over HDD in all applications is the reliability of NAND flash device, especially the endurance cycle of MLC_{X2}, MLC_{X3} and MLC_{X4} (i.e., multi-level cell with 2 bits per cell, 3 bits per cell and 4 bits per cell; in the context of this specification, the term “MLC” refers to any or all such devices with a cell storing more than one bit, and the term “MLC_{XN}” specifically refers to one type of such MLC device with N bits per cell).

A unique characteristic of the NVM cell is that every time a cell to be programmed has to be erased first. This erase and program cycle, also defined as endurance cycle, is a destructive process to the cell reliability and has certain manufacturer guaranteed number, such as 10⁶ for NOR cell, 10⁵ for SLC NAND and 10⁴ for MLC_{X2} NAND. In reality, during its life span the NAND flash memory device will always experience some early fail bits. The solution is to equip system with a mechanism to detect the bad bit and correct it, then mark the address as a bad block and avoid using it again. Therefore, the EDC/ECC and Bad block management (BBM) are becoming the standard techniques to guarantee the data integrity using NAND flash devices as storage medium.

Another fact of the computer application is that the computer will update certain files constantly, which in general resides at the same physical memory space and causes the memory space to be worn out even before other locations have been used. The so-called wear-leveling (WL) technique is introduced to shuffle around the files through out the physical space by tracking the usage of each physical location and average the usage of the whole memory space. The existing SSD structure utilizes a central controller to handle data transfer between host and NAND flash memory devices as well as BBM, EDC/ECC, and wear-leveling tasks to improve system reliability. FIG. 1 shows such a conventional system 100, which includes a SATA interface 12, an SSD controller 14 and a plurality of NAND memory devices 16, wherein all the data integrity management tasks as described above are performed by the controller 14. In order to improve system performance, up to eight channels of NAND flash memory devices were employed and processed in parallel. As such, the controller must be running at very high MIPS and even higher when the MLC_{X3} and MLC_{X4} are employed. That presents a tremendous challenge to the SSD controller.

Also as background information, in modern circuit design, NAND memories are usually erased by block and programmed by page as a unit. Various wear-leveling algorithms have been proposed to avoid writing data repetitively at the same location. To minimize the difference between maximum erase counts of block and the minimum erase counts of block is the general practice of wear leveling mechanism. This wear leveling operation will strengthen the reliability quality especially when MLCₓ₂, MLCₓ₃, MLCₓ₄ or downgrade flash memories which are employed in the system. Wear leveling methods include dynamic and static wear leveling.

The present invention provides an NVM storage system with two-stage controller architecture to improve the system performance and reliability.

### SUMMARY OF THE INVENTION

In view of the foregoing, an objective of the present invention is to provide an NVM storage system with two-stage controller architecture, which is in contrast to the conventional single centralized controller structure, so that data integrity management loading can be shared between the two stages and the overall performance can be improved.

To achieve the above and other objectives, in one aspect, the present invention discloses a non-volatile memory storage system with two-stage controller, comprising: a plurality of flash memory devices; a plurality of first stage controllers coupled to the plurality of flash memory devices, respectively, wherein each of the first stage controllers performs data integrity management as well as writes and reads data to and from a corresponding flash memory device; and a storage adapter as second stage controller communicating with the plurality of first stage controllers through one or more internal interfaces.

Preferably, the storage adapter performs wear leveling if wear leveling is not implemented in at least one of the first stage controllers, and the storage adapter performs secondary BBM function if BBM is not completed in at least one of the first stage controllers.

Preferably, the storage adapter performs RAID-0, 1, 5 or 6 operation.

A cache memory or a buffer memory, or a memory serving both as buffer and cache memory, can be coupled to the storage adapter.

Preferably, one of the plurality of flash memory devices and one of the plurality of first stage controllers are integrated into a card module, and more preferably, the one flash memory device is mounted chip-on-board to the card module.

The plurality of flash memory devices can be partitioned into two drives, one with devices having lower quality such as MLC and/or downgrade flash devices, and the other with at least some devices having higher quality such as SLC flash devices.

It is to be understood that both the foregoing general description and the following detailed description are provided as examples, for illustration rather than limiting the scope of the invention.

### BRIEF DESCRIPTION OF THE DRAWINGS

The foregoing and other objects and features of the present invention will become better understood from the following descriptions, appended claims when read in connection with the accompanying drawings.

FIG. 1 illustrates a conventional SSD system wherein data integrity management operations such as BBM, EDC/ECC, and wear-leveling tasks are all performed in a central controller.

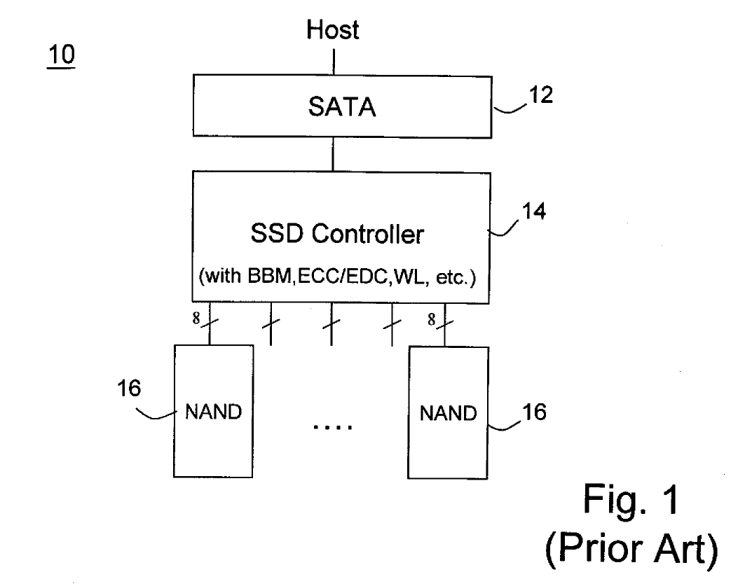

FIG. 2 is a block diagram of an SSD storage system with two-stage controller architecture, according to an embodiment of the present invention. The host interface of the storage adapter can be either one of the SATA/IDE/USB/PCI interfaces. Data integrity management tasks such as BBM, ECC/EDC, WL and virtual mapping are shared between the first stage controller and the storage adapter.

FIG. 3 is a flow chart showing a process for determining whether to perform wear leveling in the second stage controller, i.e., the storage adapter.

FIG. 4 is a flow chart showing a process for determining whether to perform bad block management in the storage adapter.

FIG. 5 shows that the storage adapter can also perform RAID operations, such as RAID level 0, 1, 5 or 6.

FIG. 6 shows another embodiment of the invention, which includes a memory module, preferably a RAM.

FIG. 7 explains the relationship between the memory module and the memory storage space of the NAND devices, i.e., how data are stored in the memory module and the NAND devices so as to enhance the endurance of the NAND devices.

FIG. 8 shows the detailed structure of the solid state data storage system as an example, and also shows the data path in correspondence with FIG. 7.

FIG. 9 illustrates another embodiment in which one RAM serves both as the cache and the buffer memory.

FIG. 10 explains the buffer/cache operation by the buffer/cache controller.

FIG. 11 shows another embodiment of the invention wherein the cache memory of the solid state data storage system includes a first level cache RAM and a second level cache SLC (single-level cell) flash memory.

FIG. 12 explains the operation of the two-level cache memory.

FIG. 13 shows an example of the solid state data storage system, and also shows the data write path.

FIG. 14 shows another embodiment of the invention wherein the system includes FIFOs as buffer.

FIG. 15 shows another embodiment of the invention which includes a PMU (Power Management Unit). The PMU is capable of reducing power consumption by driving the memories into power saving mode or decreasing the duty cycle of the internal interface ports.

FIG. 16 illustrates that the first stage controller and the flash devices are integrated into a memory card module.

FIG. 17 shows an embodiment of memory card module.

FIG. 18 shows other embodiments of memory card module wherein the NAND flash devices are bonded COB (chip-on-board) in die form.

FIG. 19 shows the layout on one side of a 1.8″ system in actual size; what is shown is a molded SD COB module using soldered μSD.

FIGS. 20 and 21 show that the flash memory devices can employ MLC_{X2}, MLC_{X3}, MLC_{X4} or downgrade parts, and thus the capacities of different memory modules will be different.

FIG. 22 shows a dual-drive architecture according to a further embodiment of the present invention.

FIG. 23 shows that the drive 1 can be partitioned into mission critical storage domain and cache memory domain.

FIG. 24 shows that the dual-drive architecture can be provided with a cache memory.

FIG. 25 shows how the SLC flash memory functions as swap space to facilitate program/write operations.

### DESCRIPTION OF THE PREFERRED EMBODIMENTS

The present invention will now be described in detail with reference to preferred embodiments thereof as illustrated in the accompanying drawings.

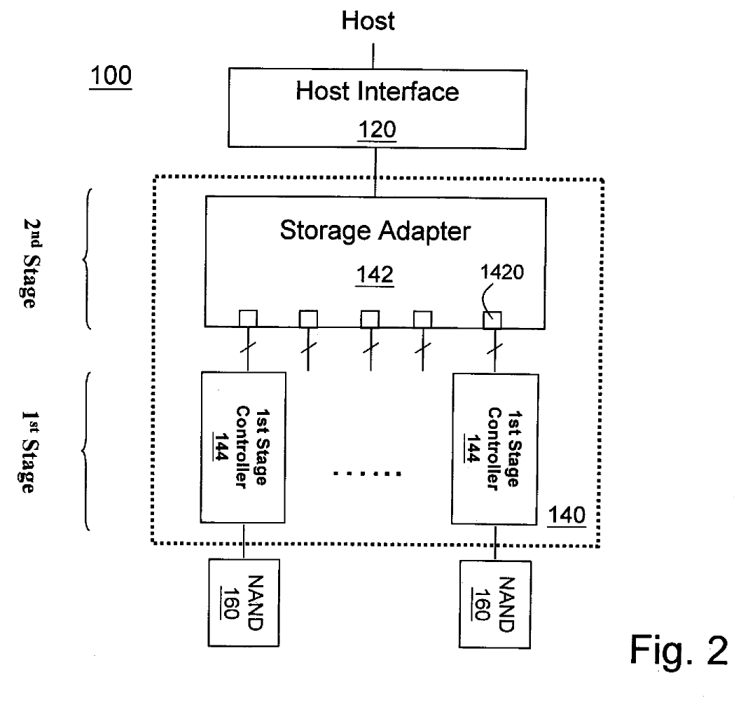

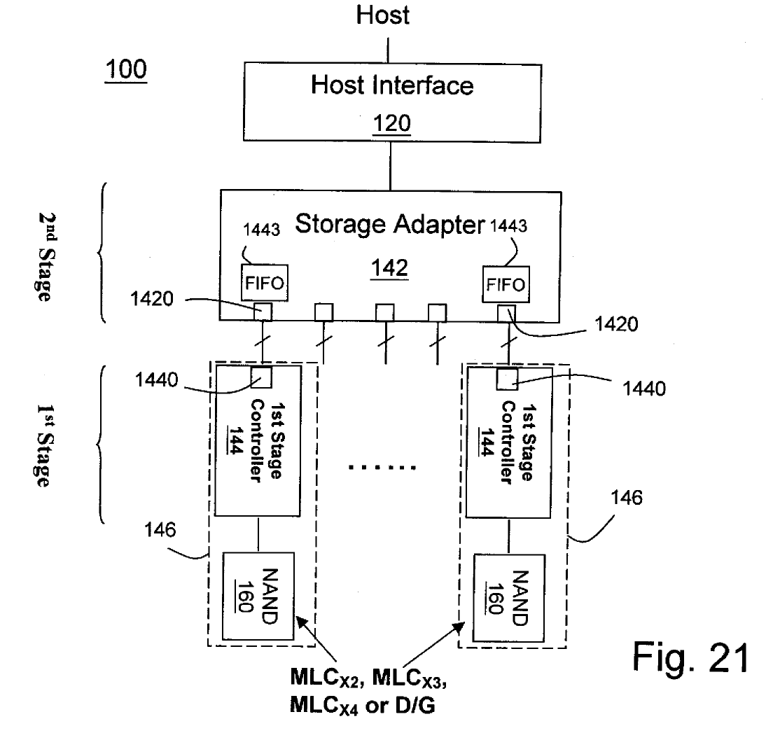

The first embodiment of the present invention is shown in FIG. 2. The solid state data storage system 100 employs two-stage controller architecture. As shown in the figure, the system 100 includes a host interface 120 for communication between the system 100 and a host; a two-stage controller 140 including a storage adapter 142 and a plurality of first stage controllers 144; and a plurality of non-volatile memory devices 160, such as NAND flash devices as shown but can be other types of NVM devices such as SONOS or CTF (Charge Trapping Flash). The host interface 120 may communicate with the host through, e.g., IDE, SATA, USB, PCI or PCIe protocol. The storage adapter 142 has a plurality of internal interfaces 1420, and it may communicate with the plurality of first stage controllers 144 through any designated protocol, such as NAND interfacing protocol (to be further described with reference to FIG. 20). The storage adapter 142 serves as a second stage controller, transferring data in stripping or parallel order to and from the first stage controllers 144. Each first stage controller 144 performs some of the data integrity management tasks such as BBM and EDC/ECC, as well as writes and reads data to and from a corresponding NAND memory device 160. In other words, the first stage controllers 144 and the second stage controller. i.e., the storage adapter 142 share the data integrity management tasks. The advantage of distributing some of the data integrity management tasks such as EDC/ECC, WL and BBM tasks to the first stage controllers 144 instead of centralizing those tasks in a central controller is that each first stage controller 144 processes only a portion (such as one eighth if there are eight NAND flash channels) of total memory cells, and thus the requirement for computing power is greatly reduced and the system can handle NAND memory devices such as MLCₓ₂, MLCₓ₃, MLCₓ₄ much easier than the conventional SSD.

Note that the data integrity management tasks can be shared between the storage adapter 142 and the first stage controllers 144 in various ways (for example, the first stage controllers 144 can perform not only EDC/ECC and BBM, but also WL and virtual mapping), and furthermore the storage adapter 142 and the first stage controllers 144 may be produced by different product providers who may not be well aligned with each other. Therefore, according to the present invention, a double-check mechanism is provided in the storage adapter 142.

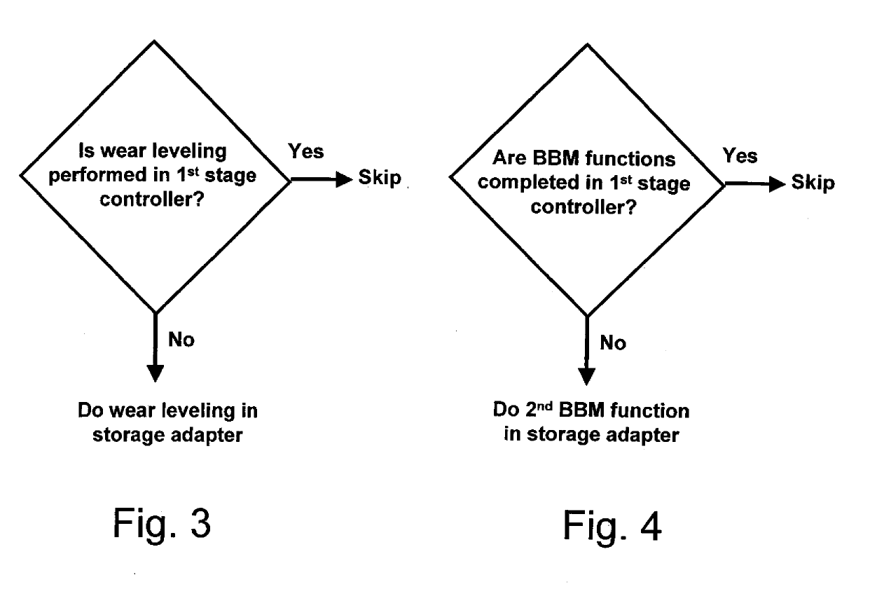

FIG. 3 shows a flow chart of performing wear leveling in the two-stage controller architecture according to the present invention. The storage adapter 142 checks whether wear leveling is implemented in each first stage controller 144. If not, the storage adapter 142 performs wear leveling function to prolong the life cycle of the system.

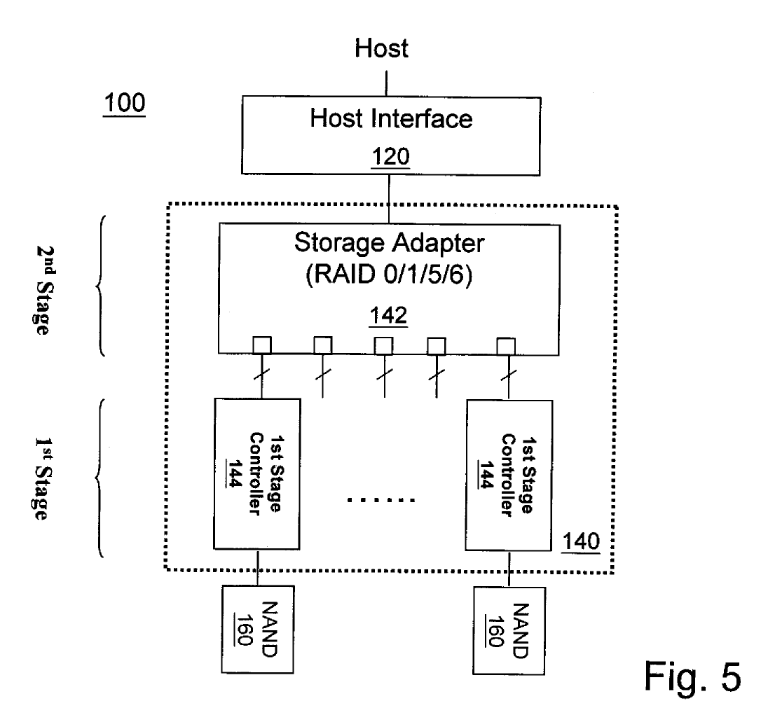

FIG. 4 shows a flow chart of performing BBM. The storage adapter 142 performs secondary BBM function if BBM is not completed in a first stage controller 144. Another possible arrangement is for both the first stage controllers 144 and the storage adapter 142 to perform BBM.

By accessing into the BBM map table of each first stage controller 144, the storage adapter 142 can perform secondary BBM with spare memory areas to improve data reliability. The spare memory areas in the NAND memory devices 160 contain available physical blocks for replacing bad blocks, which are generated either in the early or late lifetime of those devices 160. BBM map table contains information about spare physical blocks in flash memory devices. The BBM table includes the initial available spare blocks information when the users in the field start to use the data storage system. The BBM table will be updated when bad blocks are generated as time passes by along the system lifetime. The BBM table will prevent the system from accessing the bad blocks in the flash memory array.

Depending on circuit arrangement which can be designed as desired, each first stage controller 144 can perform some or all tasks of static/dynamic bad block management, ECC/EDC, static or dynamic wear leveling and virtual mapping functions, and the storage adapter 142 can perform what has not been performed in the first stage controllers 144, or, in some cases, what has been performed in the first stage controllers 144.

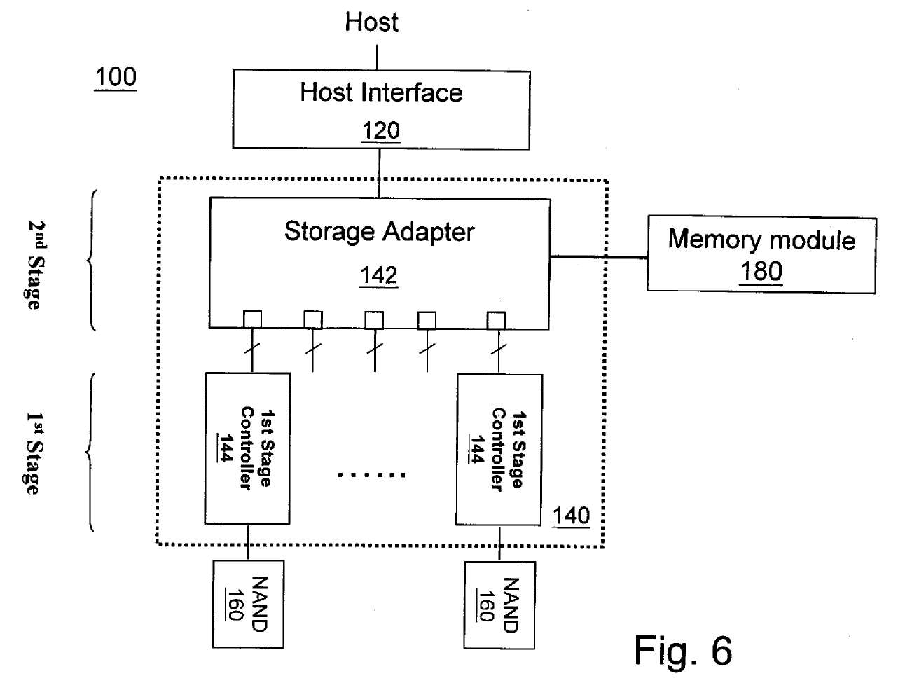

FIG. 5 shows another embodiment of this invention, wherein the storage adapter also performs RAID operation, such as RAID-0, 1, 5 or 6. The address domain of the NAND memory devices 160 can be configured into RAID level 0, 1, 5 or 6 accordingly. In brief, RAID-0 provides data striping. RAID-1 provides mirrored set without parity. RAID-5 provides striped set with distributed parity. RAID-6 provides striped set with dual distributed parity. The details of such RAID operations are omitted here because they have been described in the parent applications U.S. Ser. No. 12/218,949 and U.S. Ser. No. 12/271,885 to which the present invention claims priority.

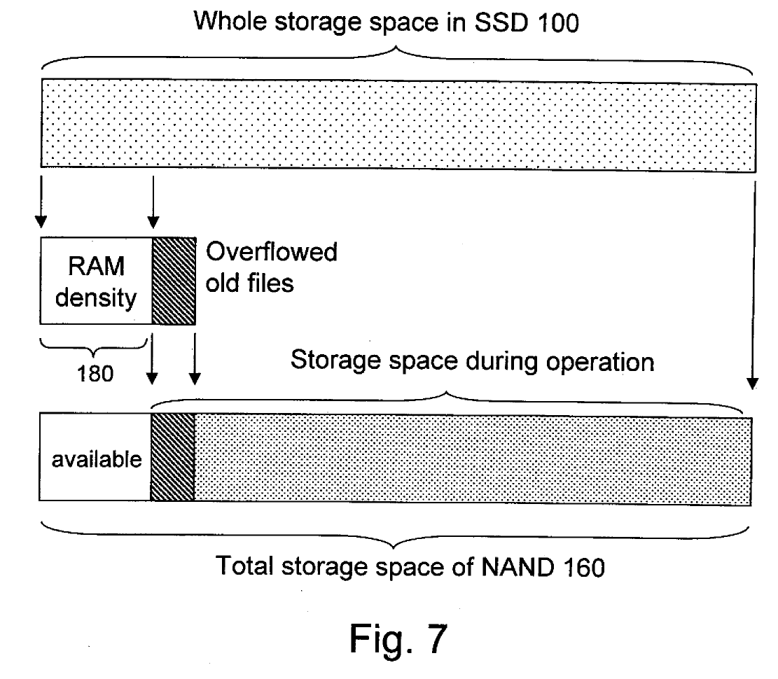

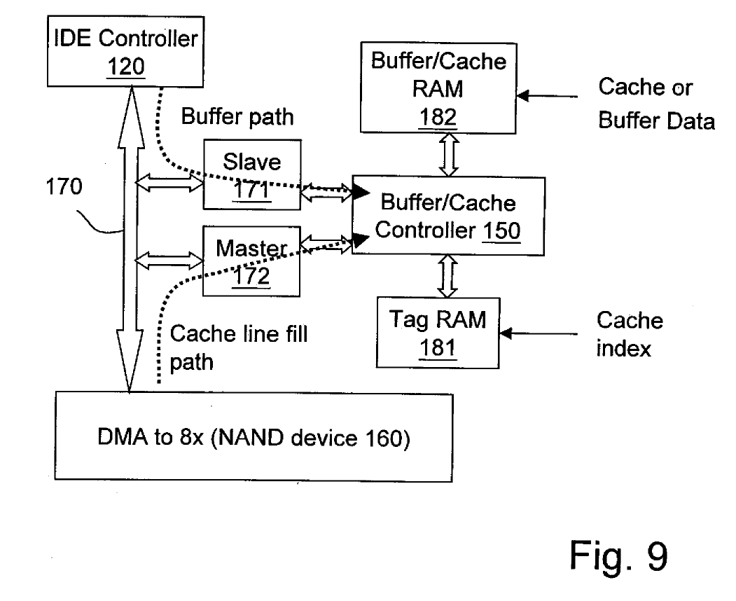

FIG. 6 shows another embodiment of the present invention which further includes a memory module 180, preferably a RAM (SRAM or DRAM) but can be otherwise, coupled to the storage adapter 142. The memory module 180 in this embodiment serves as a cache memory. This cache memory 180 is for storing frequently updated files to reduce the times of the files being written to the NAND memory devices 160, and to reduce the times of the address subject to the erase-program cycle, thus indirectly improving the endurance of flash memories. More specifically, the cache memory 180 temporarily stores the write data until the cache is full, or is over certain preset threshold amount of cache capacity, and then the data are written into the main memories (NAND devices 160 in this case). Before the power of the system is lost, the data in the cache memory 180 will be stored into the main memories. Since the endurance of DRAM or SRAM is almost infinite, the above mentioned cache operation can effectively prolong the lifespan of the NAND devices 160. The cache memory 180 can also serve as a buffer memory to increase the read and write performance of the system. This cache memory can be in the form of DRAM, SDRAM, mobile DRAM, LP-SDRAM or SRAM. As another embodiment, a memory module including both cache RAM and buffer RAM will be described later with reference to FIG. 8. The buffer RAM increases the read and the write performance of the system.

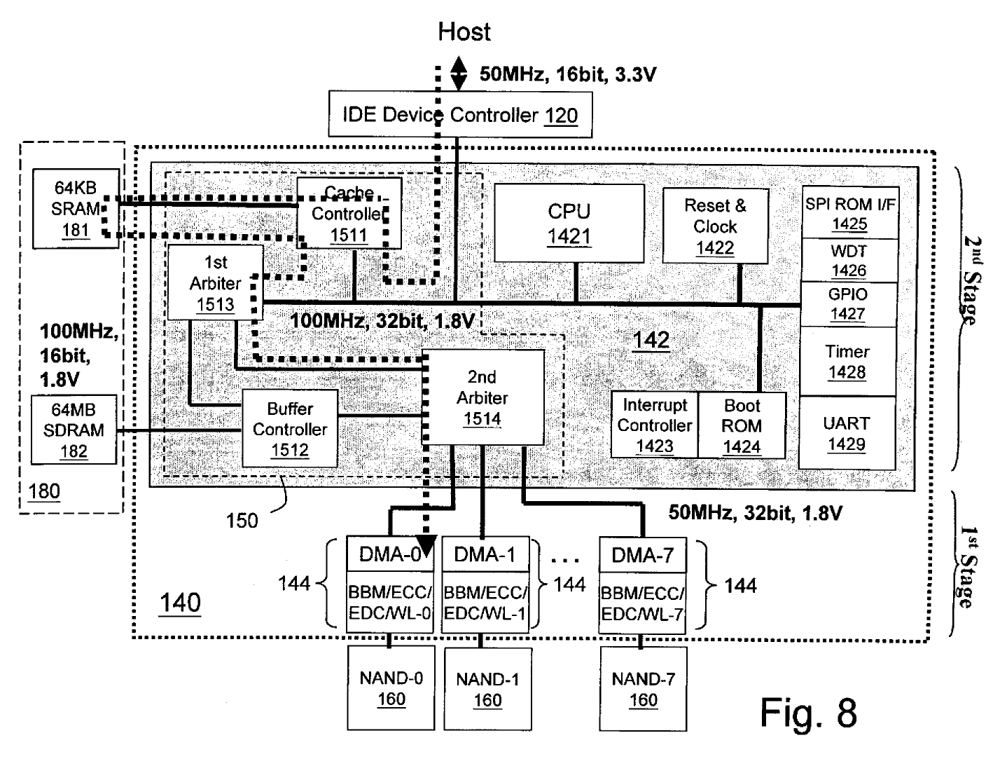

FIG. 7 shows how the cache memory 180 operates to enhance the memory endurance. The whole storage space of the solid state data storage system 100 equals to the total storage space of the NAND devices 160. During operation, frequently updated files are stored in the cache memory 180. When data in the cache memory 180 overflow, old files which are least recently used (LRU) are transferred to the main memories (NAND devices 160 in this case) to allocate space for the new file. The storage space of the main memories keeps an available space which is in equal (or larger) capacity to the density of the cache memory 180, so that at the end of the operation the content of the cache memory 180 can be stored into the main memories.

For enablement and as a more detailed example of how the present invention can be implemented, FIG. 8 shows the detailed structure of the solid state data storage system 100, and also explains how the cache memory 180 operates to enhance the memory endurance. In this example, the host interface 120 is an IDE device controller communicating with a host through a 50 MHz/16 bit/3.3V bus line. The storage adapter 142 operates in 100 MHz/32 bit/1.8V, and it includes a CPU 1421 controlling its operation, a Reset & clock 1422 providing clock signals, an interrupt controller 1423 with a boot ROM 1424 storing a boot program, a serial peripheral interface (SPI ROM I/F) 1425, a watch dog timer (WDT) 1426, a general purpose I/O (GPIO) 1427, a timer 1428, a Universal Asynchronous Receiver and Transmitter (UART) 1429, and a buffer/cache controller 150 which includes a cache controller 1511, a buffer controller 1512, and arbiters 1513 and 1514. The first stage controllers communicates with the second arbiter 1514 through a 50 MHz/32 bit/1.8V bus line, and each first stage controller includes a direct memory access circuit (DMA-0 through DMA-7) and a data integrity management circuit performing tasks such as BBM, ECC, EDC or WL. The cache memory 180 operates in 100 MHz/16 bit/1.8V, and it includes a 64 KB SRAM 181 serving as a cache and a 64 MB SDRAM serving as a buffer. The cache controller 1511 controls the cache 181, and the buffer controller 1512 controls the buffer 182. In this example, the cache 181 stores most frequently updated files, and when data in the cache 181 overflow, less recently accessed data are transferred to the NAND devices 160, as shown by the thick dot line.

Note that the structure of FIG. 8 is shown as an example; all the circuit devices, protocols and specifications shown therein are modifiable or substitutable.

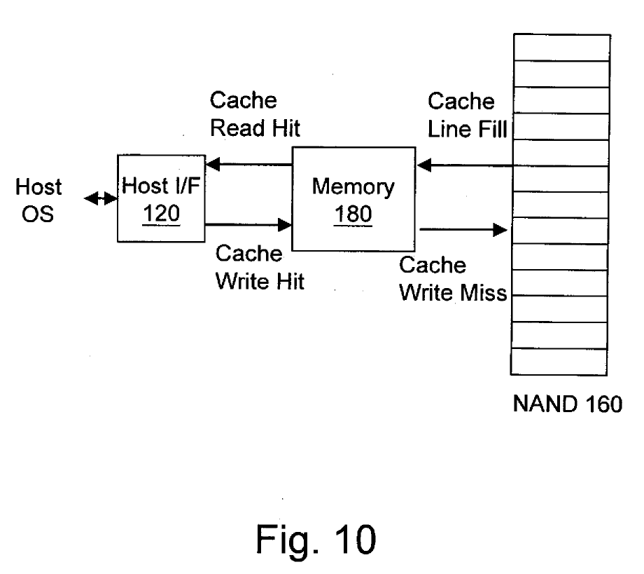

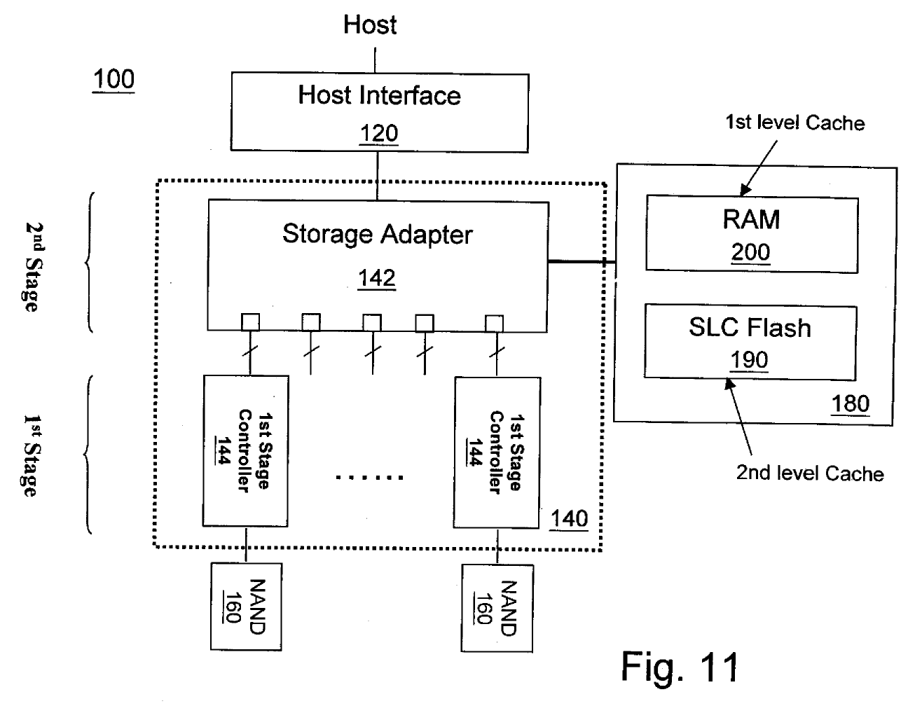

FIG. 9 illustrates another embodiment in which the RAM 182 serves both the cache and the buffer functions; the RAM 182 is preferably a DRAM but can be other types. An integrated buffer/cache controller 150 controls the buffer/cache RAM 182, which is able to control buffer operation as well as cache operation. A tag RAM is provided to store cache index or information tag associated with each cache entry. The tag RAM for example can be the SRAM 181 in FIG. 9. In this embodiment the SRAM 181 in FIG. 10 is not a data cache RAM but a tag RAM. The cache line size for example can be 4K Bytes; however due to the spatial locality effect, the cache line fill might be 16K Bytes to 64K Bytes to increase the cache hit rate. The integrated buffer/cache controller 150 communicates with the main bus line 170 through slave 171 and master 172, and the data paths (buffer data path and cache line fill path) are as shown. The larger the size of the cache line fill the better the hit rate; however the cache line fill size can not be too large, otherwise the cache memory cannot be filled quickly. Because of the need of larger buffer size, using SDRAM as buffer is one preferred choice. The cost of DRAM is lower than SRAM in terms of the same density. But the standby current is higher for DRAM due to the required refresh operation. Thus a power saving scheme for the system should preferably be provided. The power saving scheme will be described later.

FIG. 10 shows an example of the buffer/cache operation by the buffer/cache controller 150, with cache write back operation. When the host operation system (OS) requires reading data from the solid state data storage system 100, the buffer/cache controller 150 (not shown in this figure) first checks the cache memory 180 to see if the data are in the cache memory 180. If yes (read hit), data are read from the cache memory 180 so that the NAND devices 160 are less accessed. The read speed is faster from cache than from NAND devices 160. If not, data are read from the NAND devices 160 and also stored to the cache memory 180. In write operation, when the host OS requires writing data to the solid state data storage system 100, the buffer/cache controller 150 first checks the cache memory 180 to see if a prior version of the data is in the cache memory 180. If yes (write hit), the data are written to the cache memory 180 so that the NAND devices 160 are less accessed. If not, the data are written to the NAND devices 160, and read from the NAND devices 160 to the cache memory 180.

In the application for general CPU system, with a hit rate up to 80˜90% or so, a 2 MB cache memory can cover 1 GB main memory to reduce the erase/program times of the files being written to the main memory to only 10˜20% as compared to where no such cache memory is provided.

A cache RAM with a size equal to or larger than 0.2% of the frequently used region in main memories can achieve larger than 80% cache hit rate. For example, we can define 32 GB of the main memory space as frequently used region, and space beyond 32 GB as rarely used region. In this case, a 64 MB memory can cover the 32 GB main flash memories.

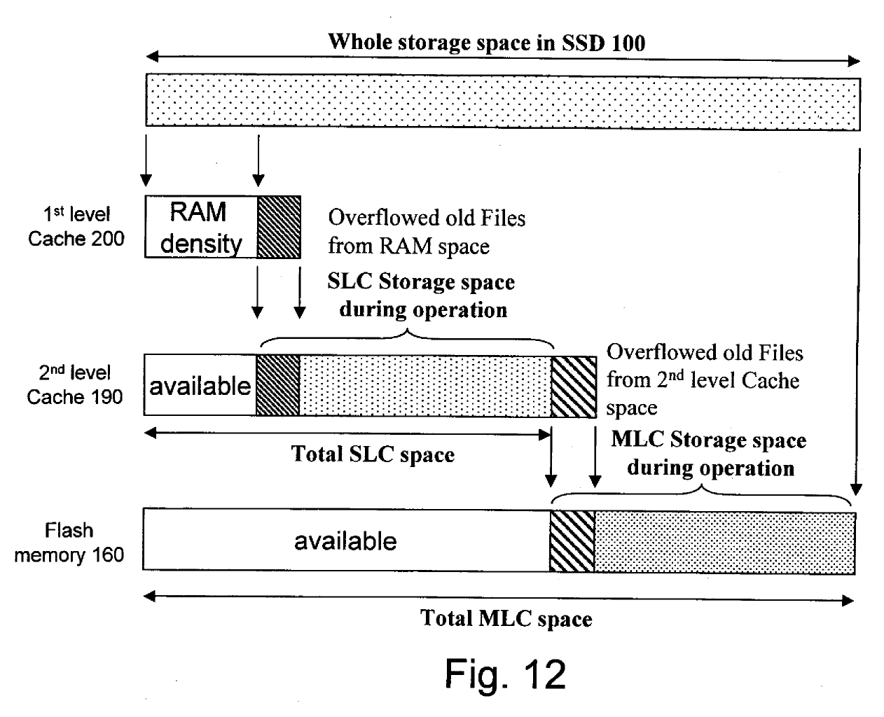

FIG. 11 shows another embodiment wherein the solid state data storage system 100 further includes an SLC (single-level cell) flash memory or NOR flash memory 190 as a second level cache. In other words, the cache memory 180 in this embodiment includes the first level cache RAM 200 and the second level cache SLC flash memory 190. This system further improves the endurance of the main memories, especially when these memories employ MLCₓ₂, MLCₓ₃, MLCₓ₄ or downgrade flash memories.

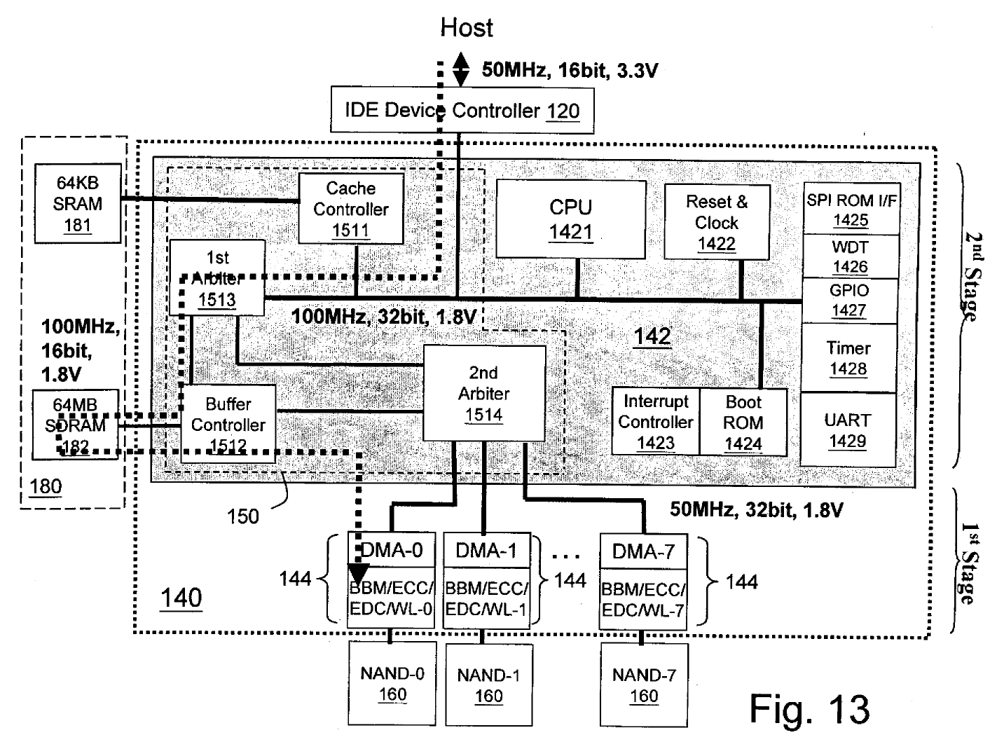

FIG. 12 explains the operation of the two level cache memory 180, assuming that the main memories employ MLC devices. When data in the cache RAM 200 overflow, old files which are least recently used are transferred to the second level cache SLC flash memory 190. The storage space of the SLC flash memory 190 keeps an available space which is in equal (or larger) capacity to the density of the cache RAM 200, so that the content of the cache RAM 200 can be fully stored into the SLC flash memory 190. When data in the SLC flash memory 190 overflow, old files which are least recently used are transferred to the main memories (MLC flash memory devices 160 in this case). The storage space of the main memories keeps an available space which is in equal (or larger) capacity to the storage space of the SLC flash memory 190, so that at the end of the operation the content of the SLC flash memory 190 can be stored into the main memories.

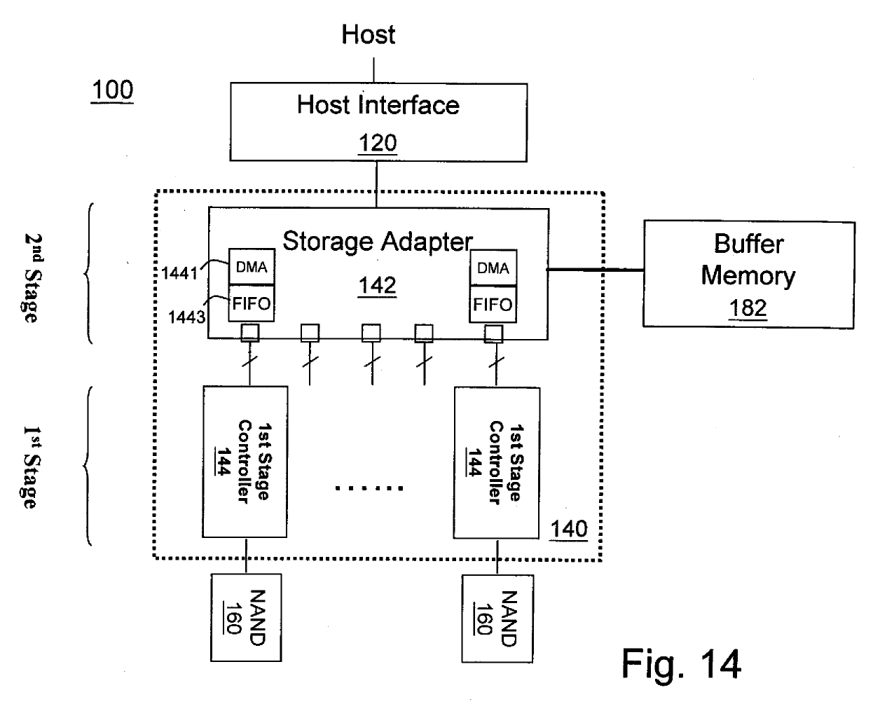

Instead of operating as a cache, a memory can be coupled to the storage adapter 142 and functioning simply as a buffer. Referring back to FIG. 6, the memory module 180 can serve just as a data buffer, storing temporary write data before loading into flash memory card modules for improving write performance. To function as a buffer, the memory 180 is preferably a DRAM to a flash memory device, since the read and the write speeds of DRAM are faster. FIG. 13 shows a more detailed circuit structure to embody the system 100, and it also shows the write path.

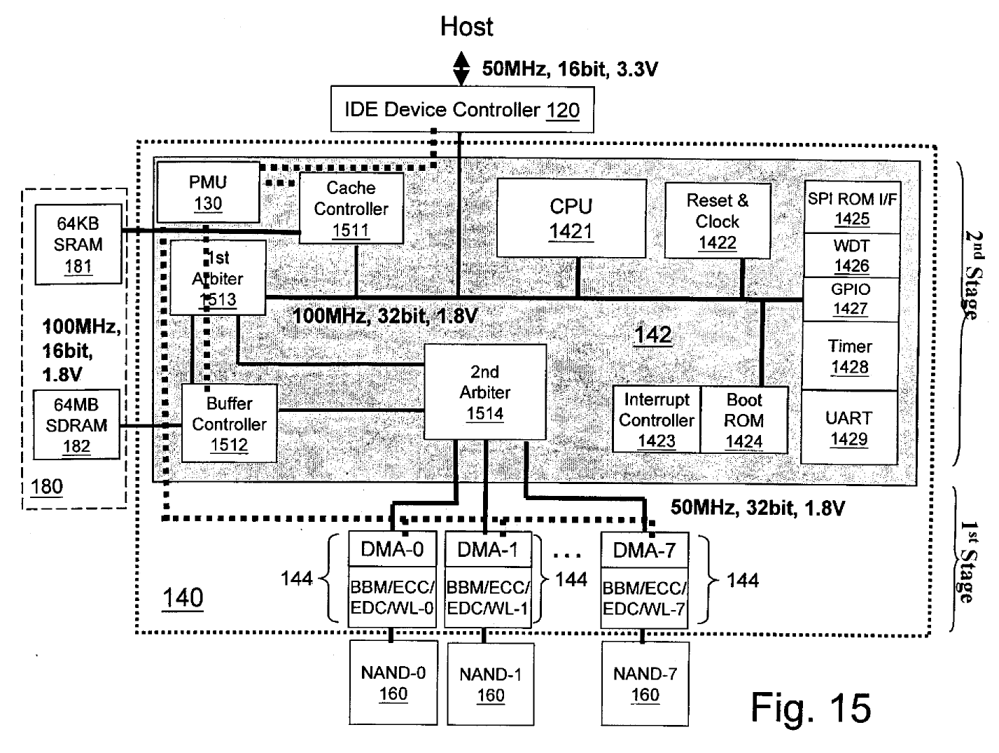

Referring to FIG. 14, the system 100 can further comprises a plurality of FIFOs 1443 as buffers to improve the speed for reading data from the NAND devices 160.

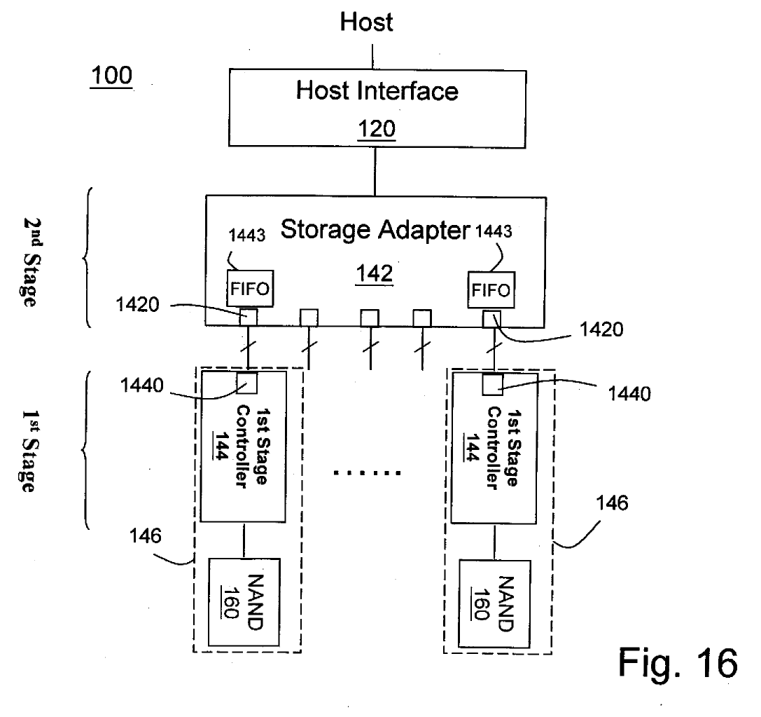

FIG. 15 shows another embodiment of the invention in which the solid state data storage system 100 further includes a PMU (Power Management Unit) 130. The PMU 130 is capable of reducing power consumption by driving the memories into power saving mode or decreasing the duty cycle of the internal interface ports. The PMU 130 detects if the system is inactive for a predetermined time period. Before the system enters the power saving mode, one of several criteria should be met, such as: that the data in the cache or buffer memory is flushed back to the main memories; that the data in the cache or buffer memory can be discarded; that the cache or buffer memory is empty; etc. The PMU 130 is able to turnoff the standby current of the unused ports, such as those ports that are not coupled to the main memory modules. The PMU 130 also manages the cache and buffer controllers 1151 and 1152 to issue the power saving mode command to RAMs 181 and 182 in order to force the RAMs 181 and 182 to enter the power saving mode. The PMU 130 also manages the power line of the RAMs 181 and 182 as well.

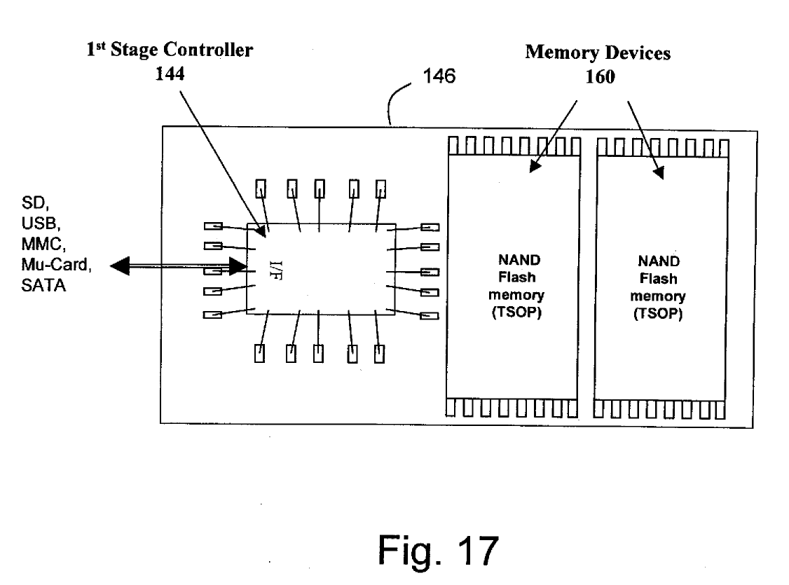

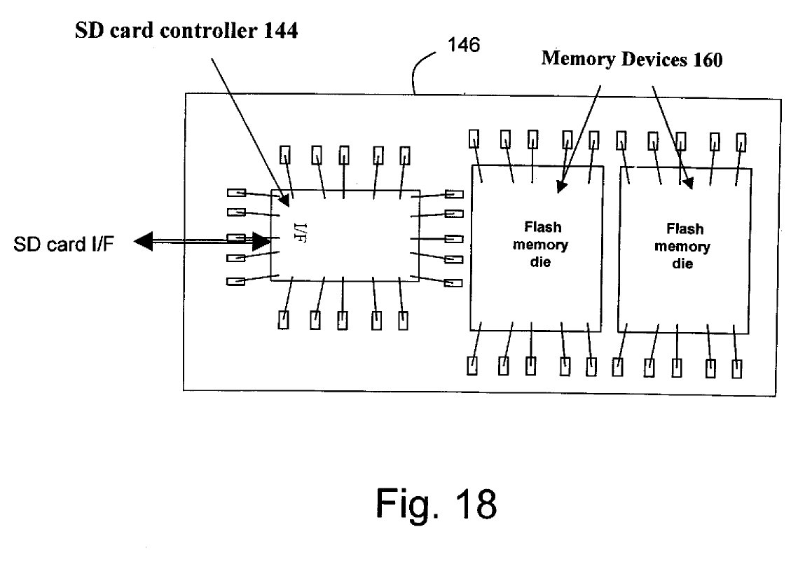

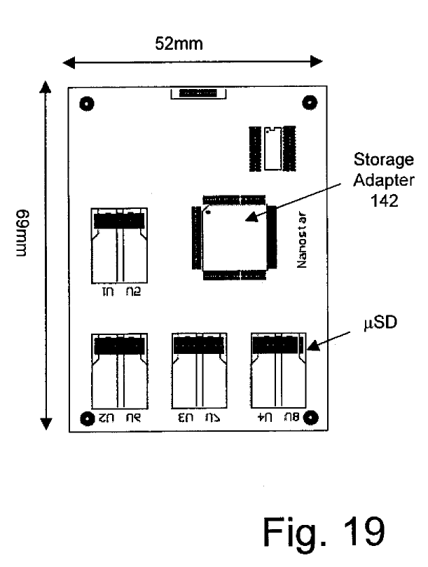

Referring to FIGS. 16 and 17, instead of NAND interface, the internal interfaces 1440 and 1420 between the first stage controllers 144 and the second stage controller (the storage adapter) 142 can be either one of the SD, μSD, USB, mini-USB, MMC, Mu-Card, SATA bus standard protocols. Some of the protocols require less number of signal lines than the NAND interfacing protocol, and thus facilitate better integration. For example, the interface link of SD protocol between the first and second controllers requires only six lines: four data lines, one clock line and one command line. As shown in the figures, by integrating a proper interface into the first stage controller 144, the first stage controller 144 can be assembled with the NAND flash devices 160 into a memory card module 146. Various types of memory card modules such as SD memory card module are applicable. Shown in FIG. 17 is one type of card module arrangement, in which the NAND flash devices 160 (note that the flash memories can be any type of NVM devices other than NAND devices, and NAND is only an example) are packaged by TSOP onto the card daughter board. The first stage controller 144 is bonded in the form of chip-on-board (COB) onto the card daughter board. However, such arrangement is not the only possible way, and there are other types of arrangements. As an example, both the controller 144 and the flash memories 160 can be bonded COB, such that the module is in a very small dimension, without unnecessary sockets and cases, as shown in FIG. 18. In FIG. 18, the flash memories 160 are in die form and wire-bonded to the card board.

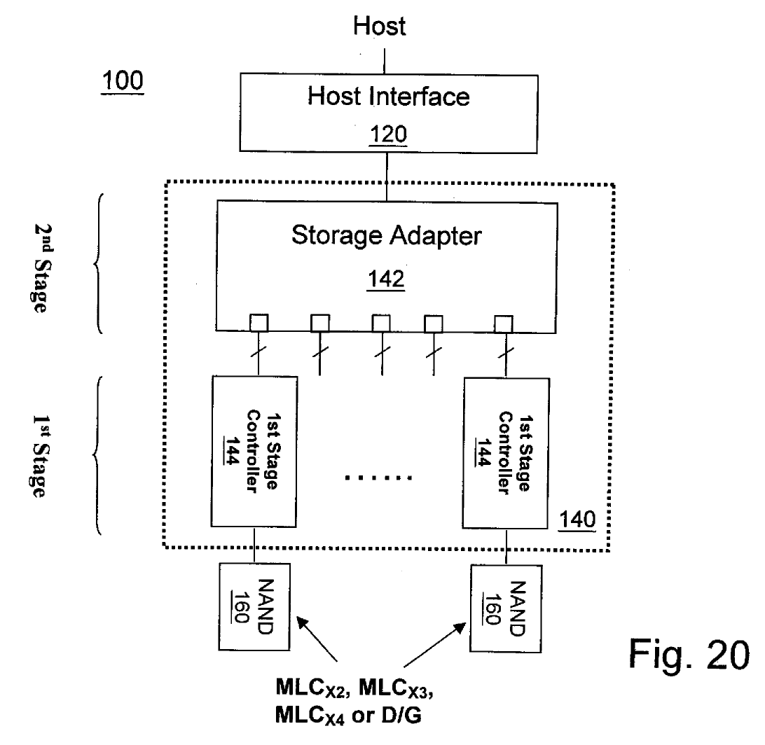

As shown in FIG. 19, the memory card module employing COB flash memory devices has the advantage of smaller dimension. According to the present invention, three or more COB memory card modules can be assembled on a small form factor system board. What FIG. 20 shows is the exact actual size, and as shown in the figure, on a 69 mm×52 mm board can be mounted, besides the storage adapter 142, eight memory card modules U1-U8 (wherein U5-U8 are mounted on the back side of the board). Each card module is of a size similar to the μSD card size, as shown by the photo for comparison. The interface for COB memory card modules can be SD, μSD, USB, mini-USB or SATA bus protocol. The memory card module can be one of a SD card, μSD card, SATA card, USB card, mini-USB card, Cfast card and CF card module.

The present invention has a great advantage that it has taken care of the three most critical issues, namely the read, write and endurance issues involved in the flash memory devices. Therefore, the flash memory devices 160 in all of the above embodiments can use less reliable devices such as MLC_{X2}, MLC_{X3}, MLC_{X4} and downgrade flash memory devices. With respect to the “downgrade” memory device, when the bad blocks therein are over certain percentage of the total available blocks, the memory chip is considered as a downgrade chip. The industry standard, in general, categorizes the grades as Bin 1, Bin 2, Bin 3, and Bin 4, etc. by the usable density percentage of above 95%, 90%, 85%, 75%, etc., respectively. In the context of this invention, any flash memory chip that does not belong to Bin 1, i.e., any device having a usable density percentage below 95%, is referred to as a downgrade flash chip. Because the SSD storage system 100 in this invention not only manages the data transfer and other interrupt request, but also takes care of the data integrity issues, such downgrade chips can be used in the system with much better performance than its given grade, even though a downgrade chip is expected to fail earlier. For one reason, the memory module 180 helps to reduce the loading of the flash memory devices. For another reason, if the wear leveling is not performed in the first stage controller 144, then the storage adapter 142 will perform the wear leveling operation to prolong the life cycle of the system. This wear leveling will strengthen the reliability quality especially when downgrade flash memories are employed in the system.

Preferably, the memory card modules are configured under a RAID engine. Equal density of valid flash memory blocks is configured for each memory card module for the specific volume if those modules are included in this specific volume. There is a spare blocks map table for each module to list the spare blocks information. The spare blocks listed inside the spare blocks map table can be used to replace the bad blocks in other flash memories within the same module to maintain the minimum required density for the RAID engine. This mechanism prolongs the lifetime of the flash modules, especially when downgrade flash memories are used inside these flash modules. As explained in the previous paragraph, downgrade flash memory chips have valid blocks less than 95% of the total physical memory capacity, so they do not have enough spare blocks for failure replacement; therefore, RAID and wear-leveling become more important. For more details of the RAID and wear-leveling technique, please refer to the parent applications U.S. Ser. No. 12/218,949 and U.S. Ser. No. 12/271,885 to which the present invention claims priority.

Referring to FIGS. 20 and 21, when MLC or downgrade chips are used, the memory devices or card modules may have different densities because each device may contain a different volume of available blocks.

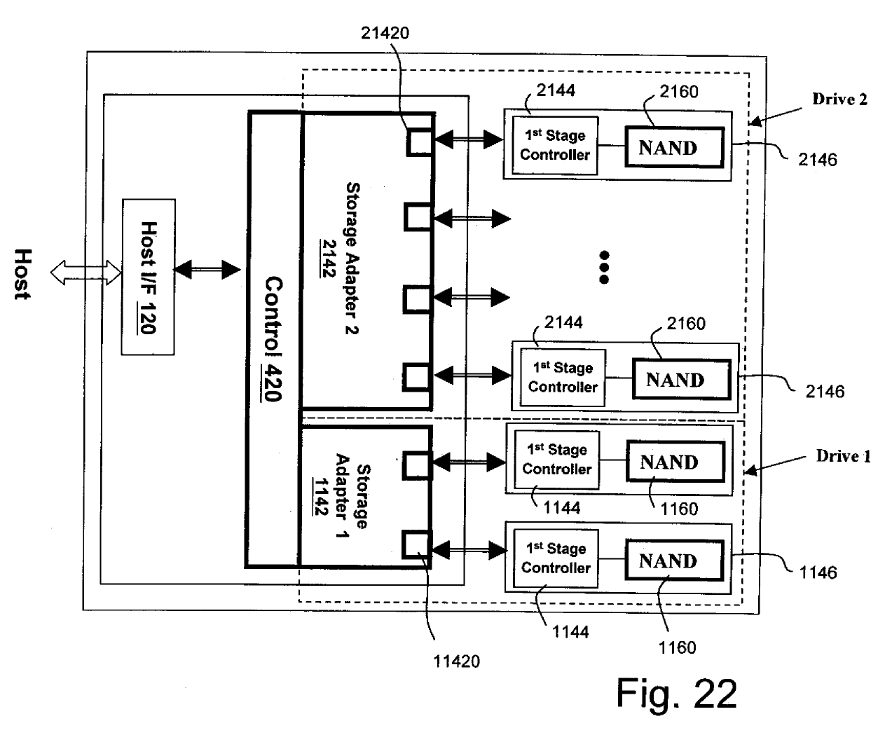

FIG. 22 shows a dual-drive architecture according to a further embodiment of the present invention. In this embodiment, the drive 1 uses high speed and highly reliable flash memory chips such as SLC flash memory chips, while the drive 2 uses low speed but high density flash memory chips such as MLC flash memory chips. The architecture of each drive can be of any form, such as the one in FIG. 2. The drive 1 includes a storage adapter 1142 and the drive 2 includes a storage adapter 2142; both storage adapters are controlled by a control circuit 420. The storage adapters 1142 and 2142 have a plurality of internal interfaces 11420 and 21420, respectively, and communicate with the memory card modules 1146 and 2146 through these internal interfaces. The memory card modules 1146 and 2146 include first stage controllers 1144 and 2144, and flash memory devices 1160 and 2160, respectively. The host interface 120 for example can be an IDE, SATA, or other interface. The advantage of this invention is to store mission critical data such as boot code, application code, OS code and so on in the drive 1 due to its high reliability. Together with its high speed in write (in comparison with drive 2), drive 1 can be further used as cache memory for the main drive 2, the latter being slower but cheaper, and the result is a system that is reliable but with reasonably low cost.

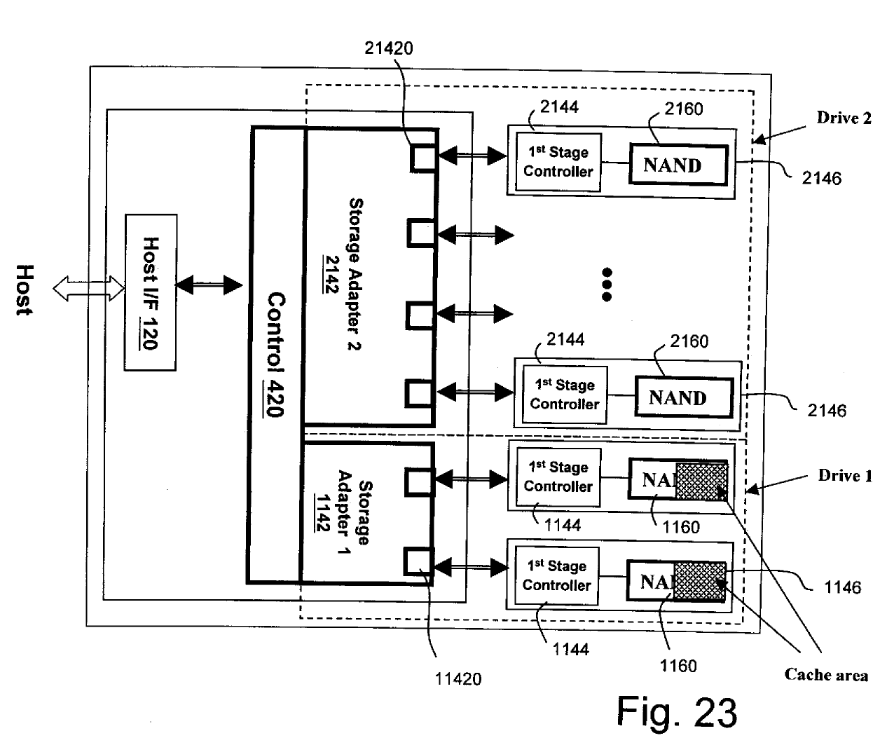

In order to meet the above criteria, SLC memory chip is one among the preferred choices for drive 1 memory chips since its endurance cycle is at least one order magnitude better than that of MLC_{X2} and probably two order magnitude better than MLC_{X3} chips. As such, the use of SLC in drive 1 for OS code or mission critical data will enhance the reliability of the system. Also SLC is about three times faster in write than MLC is, and the SLC read speed is faster than that of MLC. The transfer rate can be maximized in drive 1, e.g., using SATA port as local bus, and drive 1 can serve as cache memory for the system at the same time. Considering that the Window OS code is in general about 1 GB in density, the drive 1 needs only few Giga Byte memory density to fulfill the requirement as mission critical storage; therefore the memory devices 1160 in drive 1 can be partitioned into two domains as shown in FIG. 23, one for the OS code and the other as cache. On the other hand, the drive 2 as the main storage area can use MLC_{X2}, MLC_{X3}, MLC_{X4} or downgrade chips, so that the overall system is very reliable but relatively low cost.

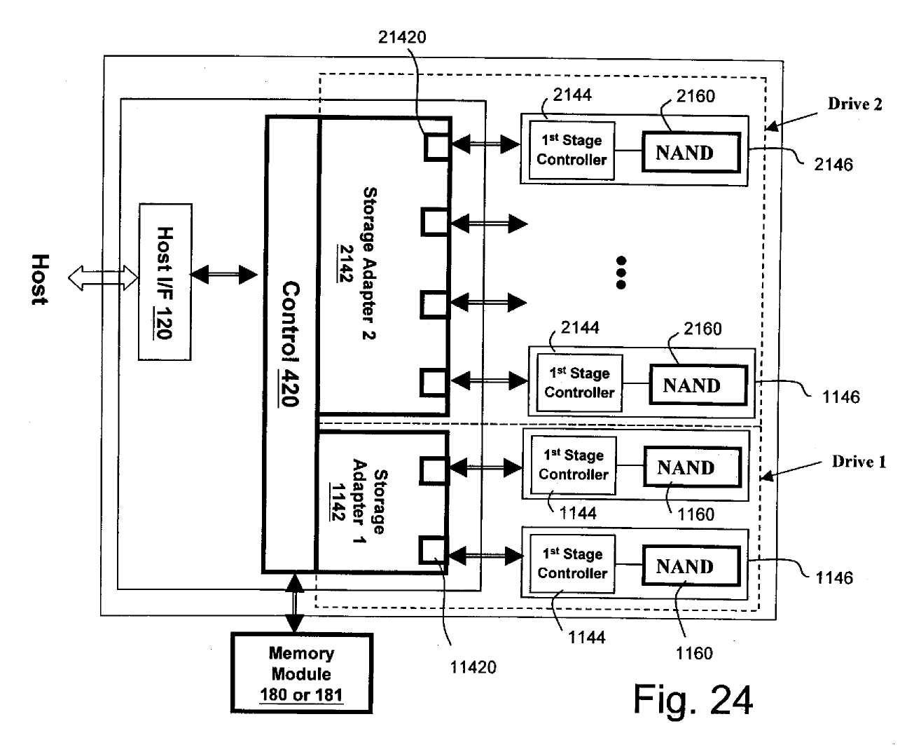

The drive 2 can be configured as RAID architecture. In another embodiment as shown in FIG. 24, the dual-drive system further includes a first level cache memory for updating frequently used files to improve endurance. The cache memory may be one of the memories module 180 and 181 shown in FIGS. 6, 8 and 11.

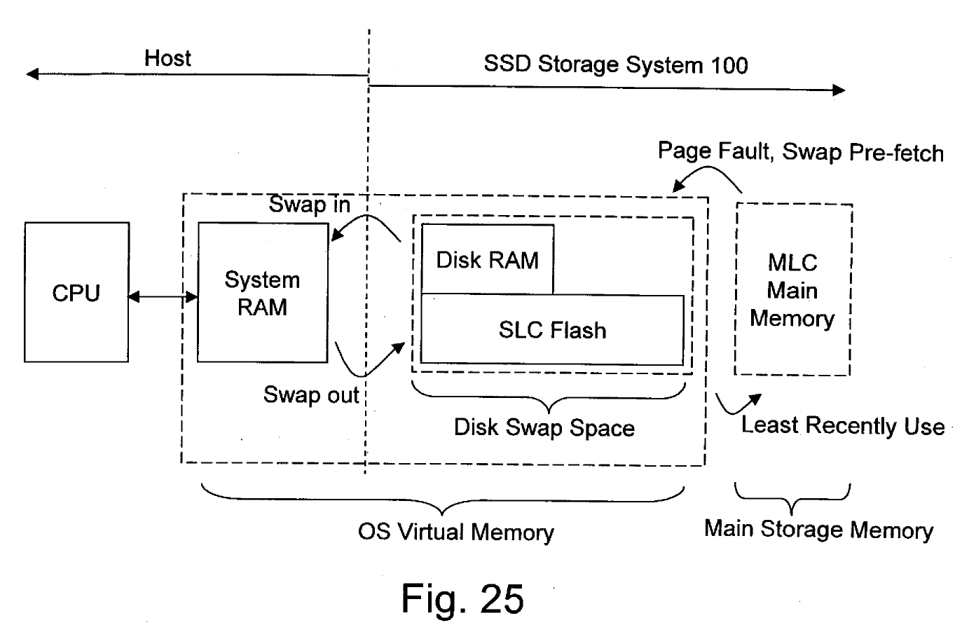

FIG. 25 explains how the disk RAM and SLC flash memory functions as swap space to facilitate the program/write operations. As shown in the figure, from the viewpoint of the overall computer system, this is a two-level cache architecture wherein the disk RAM is the first level cache and the SLC flash is the second level cache, while the MLC flash memory in the SSD storage system 100 is the main memory. The first and second level cache memories and system RAM form an OS virtual memory space. Virtual memory technique in computer system gives an application program the impression that it has contiguous working memory space. The disk swap space is a hot spot area with more program, erase and read operation cycles. In this embodiment, the SLC flash memory can be dynamically used as part of the swap space if more swap space is needed. The address space of the disk RAM can be made overlapping with the SLC flash address space. The combination of disk RAM and SLC flash memory enjoys both the benefits of the high endurance and high speed of DRAM and the non-volatile characteristics and lower cost per bit (compared with DRAM) of SLC flash memory. A page is a set of contiguous virtual memory addresses. Pages are usually at least 4K bytes in size. The swap pre-fetch technique preloads a process non-resident pages that are likely to be referenced in the near future into the physical memory of the virtual memory. The page fault condition happens when the virtual memory page is not currently in physical memory allocated for virtual memory. The page fault condition generates data write to physical memory of the OS virtual memory from other main storage memory. The disk trashing referring to frequent page faults is generally caused by too many processes competing for scarce memory resources. When the trashing happens, the system will spend too much time transferring blocks of virtual memory between physical memory and main storage memory. The disk thrashing can result in endurance failure of the swap space memories due to data write from storage main memory to physical memory of virtual memory if these memories have poor reliability quality, such as MLC flash.

Although the present invention has been described in detail with reference to certain preferred embodiments thereof, the description is for illustrative purpose, and not for limiting the scope of the invention. One skilled in this art can readily think of many modifications and variations in light of the teaching by the present invention. In view of the foregoing, all such modifications and variations should be interpreted to fall within the scope of the following claims and their equivalents.

What is claimed is:

1. A non-volatile memory storage system with two-stage controller, comprising:
a plurality of flash memory devices;
a plurality of first stage controllers coupled to the plurality of flash memory devices, respectively, wherein each of the first stage controllers performs data integrity management as well as writes and reads data to and from a corresponding flash memory device;
a storage adapter as second stage controller communicating with the plurality of first stage controllers through one or more internal interfaces; and
a host interface coupled to the storage adapter for communicating with an external host.

2. The non-volatile memory storage system of claim 1, wherein the host interface is one of the SATA, IDE, USB and PCI interfaces.

3. The non-volatile memory storage system of claim 1, wherein the plurality of flash memory devices are one selected from the group consisting of: SLC (single level cell) flash devices; MLC (multiple level cell) flash devices; downgrade flash devices; and a combination of two or more of the above.

4. The non-volatile memory storage system of claim 1, wherein the storage adapter performs wear leveling if wear leveling is not implemented in at least one of the first stage controllers.

5. The non-volatile memory storage system of claim 1, wherein the storage adapter performs secondary BBM function if BBM is not implemented in at least one of the first stage controllers.

6. The non-volatile memory storage system of claim 1, wherein the storage adapter performs RAID-0, 1, 5 or 6 operation.

7. The non-volatile memory storage system of claim 1, further comprising a memory module coupled to the storage adapter, serving as a buffer memory, a cache memory, or both, wherein the memory module includes one or more of DRAM, SDRAM, mobile DRAM, LP-SDRAM SRAM, NOR and SLC NAND.

8. The non-volatile memory storage system of claim 7, wherein the memory module includes a first level cache RAM and a second level cache which is an SLC flash device or a NOR flash device.

9. The non-volatile memory storage system of claim 1, further comprising a buffer/cache RAM coupled to the storage adapter and providing both buffer and cache functions, and wherein the storage adapter includes a buffer/cache controller for controlling the buffer/cache RAM; and the non-volatile memory storage system further comprising a tag RAM coupled to the buffer/cache controller for storing cache index.

10. The non-volatile memory storage system of claim 1, wherein each of the plurality of first stage controllers includes a FIFO, a DMA coupled to the FIFO, and a data integrity management circuit coupled to the FIFO.

11. The non-volatile memory storage system of claim 1, further comprising a power management unit for driving the system into power saving mode.

12. The non-volatile memory storage system of claim 1, wherein the one or more internal interfaces are one selected from the group consisting of: SD, USB, MMC, Mu-Card, and SATA bus standard.

13. The non-volatile memory storage system of claim 1, wherein one of the plurality of flash memory devices and one of the plurality of first stage controllers are integrated into a card module, wherein the card module is one of a SD card, μSD card, SATA card, USB card, mini-USB card, Cfast card and CF card module.

14. The non-volatile memory storage system of claim 13, wherein the flash memory device is mounted chip-on-board to the card module, and the storage adapter and the card module are assembled on a small form factor system board, with the small form factor system board including three or more card modules.

15. The non-volatile memory storage system of claim 1, wherein the plurality of flash memory devices are partitioned into two drives, the first drive including a first portion of the plurality of flash memory devices having higher quality, and the second drive including a second portion of the plurality of flash memory devices having lower quality.

16. The non-volatile memory storage system of claim 15, wherein the second portion of the plurality of flash memory devices includes MLC or downgrade flash devices and the first portion of the plurality of flash memory devices includes SLC flash devices.

17. The non-volatile memory storage system of claim 15, wherein the first drive stores mission critical data or is used as disk swap space of virtual memory.

18. The non-volatile memory storage system of claim 15, further comprising a first level cache memory coupled to the storage adapter, and wherein the first portion of the plurality of flash memory devices serves as second level cache function.

19. A non-volatile memory storage system with two-stage controller, comprising:
a plurality of flash memory devices;
a plurality of first stage controllers coupled to the plurality of flash memory devices, respectively, wherein each of the first stage controllers performs data integrity management as well as writes and reads data to and from a corresponding flash memory device;
a storage adapter as second stage controller communicating with the plurality of first stage controllers through one or more internal NAND interfaces; and
a host interface coupled to the storage adapter for communicating with an external host.
